(19) United States
(12) Patent Application Publication
(10) Pub. No.: US 2017/0064931 A1
(43) Pub. Date: Mar. 9, 2017

(54) BEEHIVE FOR THE TREATMENT OF A COLONY OF BEES AGAINST THE INFESTATION BY MITES, AND METHOD OF TREATMENT

(71) Applicant: Mauro Tagliaferri, Gubbio (IT)

(72) Inventor: Mauro Tagliaferri, Gubbio (IT)

(21) Appl. No.: 15/108,301

(22) PCT Filed: Dec. 1, 2014
(86) PCT No.: PCT/IB2014/066482

§ 371 Date: Jun. 26, 2016

(30) Foreign Application Priority Data
Dec. 9, 2013 (IT) RN2013A000051

(51) Int. Cl. A01K 51/00

(52) U.S. Cl. CPC A01K 51/00

(57) ABSTRACT

A beehive suitable for the treatment of a colony of bees inside it against the infestation of mites, includes a plurality of frames for supporting honeycombs. The frames do not have pre-built honeycombs to house the eggs of the bees, so that they are built by the bees to suit their needs. The frames are able to be heated inside the beehive, up to a maximum temperature of less than 45° C.

### BACKGROUND

In the field of apiculture it has been known for some time, and at a global level, that there is a problem of infestations by Varroa mites. This mite is indeed able to destroy entire colonies to the point that on various occasions there has been talk of the risk of whether bees themselves will survive as a species. The extinction of bees, or even a considerable reduction in their number, would not only be a loss in itself, but it would alter a food chain that humans are part of. Indeed, bees are the main means by which pollination occurs and therefore they are largely responsible for the production of every plant species. Without bees, plants themselves would have to adapt or die off.

The fight against Varroa has yet to lead to any effective result in the long term.

The Varroa mite reproduces in the brood cells of bees, favouring male broods. As a result there is a first difficulty due to the fact that the various types of bees, in various parts of the world, have different ways of brooding. For example, some gather together the male broods, whereas others make no distinction. It is thus impossible to use a selective method.

Currently, treatments with chemical products are mainly used, with the drawback that they are found in the production of wax, honey and royal jelly, propolis and bee venom and also the parasites develop resistance to the various chemical products, becoming immune within a few years.

Some apiarists, in the attempt to obtain biological production, apply forced swarming before the mite eggs hatch, but, apart from how much of a burden this is, especially for large number of colonies, the new bee broods are in any case lost.

Alternatively the brood frames are extracted from the hives and are destroyed in an oven, killing the mites but the times and methods of execution are prohibitive.

Patent application U.S.2012/202403 discloses heatable frames with pre-built honeycombs of dimensions typical of the male broods of some species of bees. A single heatable frame with honeycombs for male broods is inserted in any hive and heated to 65° C. destroying both the mites and the male brood. The heating element is the traces of a PCB, or resistance wires.

Unfortunately, such a device cannot be used universally, since some species of bees do not tend to distinguish male broods from female ones but make mixed broods. Moreover, the device accepts slight damage to the colony of bees (the loss of the male brood) to get a disinfestation that could not be complete.

Finally, their construction is not liked by bees, which tend not to use them avoiding the wires of the resistance and the traces of the PCB.

Another similar example is known from international patent application WO02/43475, where equally a heatable frame with honeycombs for male broods is inserted in a hive. Also in this case the heating elements are electrical wire resistances. The drawbacks are therefore the same as those indicated above.

In the field it is also known from European patent application EP0800764 to regulate the temperature of a beehive to allow the bees to be active throughout the year. Such temperature regulation does not, however, seem relevant in the elimination of an infestation by mites.

### SUMMARY OF THE EMBODIMENTS

A beehive for the treatment of a colony of bees protects against the infestation of mites and a relative treatment method against such an infestation. The beehive has been developed with particular reference to infestations by Varroa mites, however this does not exclude the use of the beehive against other types of mites or other parasites.

### BRIEF DESCRIPTION OF THE DRAWINGS

Further characteristics and advantages of the present invention will become clearer from the following detailed description of preferred embodiments thereof, made with reference to the attached drawings and given for indicating and not limiting purposes. In such drawings:

FIG. 1 schematically represents a perspective view of a beehive according to the present invention;

FIG. 2 schematically represents the beehive of FIG. 1 in exploded view;

FIG. 3 schematically represents a perspective view of a frame for a beehive according to the present invention;

FIG. 4 represents an exploded view of the frame of FIG. 3;

FIG. 5 represents an enlarged view of a detail of the frame of FIG. 3; and

FIGS. 6 to 8 show an alternative embodiment of a beehive according to the present invention.

### DETAILED DESCRIPTION OF THE EMBODIMENTS

### Introduction

A general purpose of the present invention is to totally or partially overcome the problem of the prior art.

A preferred purpose of the present invention is to provide a device for treating against the infestation of mites, and in particular Varroa mites, of any colony of bees, without destroying the eggs and/or the larvae and/or the pupae and/or the adult bees.

Another further preferred purpose of the present invention is to provide a trapping frame that can be used with any type of bees.

Another further preferred purpose of the present invention is to provide a process for treating against infestations by parasites of a colony of bees that is easy and cost-effective to make.

According to a first general aspect the present invention concerns a beehive suitable for the treatment of a colony of bees inside it against the infestation of mites, characterised in that it comprises:
a plurality of frames for supporting the honeycombs (10) wherein said frames do not have pre-built honeycombs to house the eggs of the bees, so that they are built by the bees to suit their needs, said frames being able to be heated inside the beehive (5),
the frames being able to be heated up to a maximum temperature of less than 45° C.

In this way, advantageously, the device can be used with any species of bee and it is possible to extend the disinfestation at a universal level. The disinfestation is also more complete and effective with respect to the devices of the prior art, especially if the frames of the beehive are all heatable and without honeycombs.

In practice, instead of putting the frames in an oven, also destroying part of the colony of bees, or instead of adopting a frame-oven that destroys the bee larvae, the beehive is made into a sort of oven for destroying Varroa, but not bees, thanks to the management of the heating, with considerable simplification (and efficiency) of the disinfestation operations.

According to the invention, advantageously, the heatable frames can be left permanently in the beehive allowing the bees to choose which ones to places their eggs on, and the non-invasive treatment can be carried out on all of them.

In general, it is preferable to be able to control the heating so that it is within a predetermined time period, and for this reason it is preferable for the beehive to comprise at least one control device programmed to manage the parameters of temperature and time spent in the heated state of the frames. For example, by keeping the Varroa mites at a temperature of about 40° C. for more than one hour they are 100% eliminated, whereas the bees survive since the temperature is not lethal to them up to 45° C. Although it is possible to have such a device for each or for some frames, it is preferable for it to manage all of the heatable frames.

Moreover, it is not necessary to distinguish between male and female broods, and above all it is not necessary to use chemical products that end up in honey, in royal jelly, in propolis, in bee venom, and in wax. Finally, it is possible to build the frames of a hive all the same.

According to some embodiments that are particularly simple to make said frames are extractable from the beehive, and when inserted in the beehive they are supported on support elements comprising electrical contacts capable of exchanging current with corresponding electrical contacts of the frames so as to provide them with the current to make them heat up.

In this case, the use is particularly practical if said electrical contacts are in a position such that the insertion of the frames in the beehive in a position supported by the support elements places said electrical contacts in operative contact with each other, or in a position such that they can be placed in operative contact through a bayonet or through screw device.

Since the apiarist can thus extract the frames and check them, he could also decide that not all of them need treatment, so that some preferred embodiments are particularly advantageous in which the beehive comprises at least one enabling/exclusion device able to be selectively actuated by the apiarist to allow or prevent the heating of at least one frame, more preferably through one or more enabling/exclusion devices each frame can be activated or excluded from heating independently from the others. For example, each frame can be associated with such an enabling or exclusion device.

In order to best manage the treatment through the plurality of frames the beehive preferably comprises a external temperature sensor and/or an internal temperature sensor of the beehive, and a control device configured to heat all of the heatable frames simultaneously if the external and/or internal temperature is below a predetermined temperature and to heat the frames according to at least one predetermined sequence if the external and/or internal temperature is above said predetermined temperature.

In this way, the temperature inside the hive has less probability of reached values uncomfortable or lethal for bees.

According to some preferred embodiments of the invention each heatable frame comprises at least one peripheral framework, at least one plate with faces able to be heated homogeneously and a bee's wax cover placed directly on said faces and on which the bees will build the honeycombs to suit their needs. The cover preferably completely shields the plate.

In this way, the bees do not notice particular uncomfortable concentrations of heat, and due to the wax cover they are aware of the presence of a natural material and are motivated to build the honeycombs on the heatable frame and to place the broods.

According to a general preferable characteristic of the invention, in order to facilitate the preservation of the bees, the beehive comprises at least one device for removing heat from inside it, able to be actuated selectively or automatically actuated at least during the treatment periods.

In this case, preferably, the treatment beehive comprises at least one temperature sensor to measure its internal temperature, and it is programmed to actuate the heat removal device based on the internal temperature detected.

According to a second aspect thereof the invention concerns a method for treating a colony of bees against the infestation of mites, characterised in that it comprises the following steps:
heating all of the brooding areas, male and female, of a beehive to a first temperature sufficient to kill possible mites;
controlling the temperature of said brooding areas and/or of the inside of the beehive so that it remains below a predetermined temperature suitable for not killing the eggs, larvae, pupae and adult bees.

According to some preferred embodiments said heating of the brooding areas is taken to a maximum temperature of less than 45° C., and/or said internal temperature of the beehive is kept less than or equal to 35° C.

In general, it should be observed that by introducing frames into the beehive the bees make the honeycombs over them, in which they place the eggs, for which reason the brooding areas become areas of the frames or coincide with the frames themselves. It is therefore preferable to arrange a plurality of heatable frames for supporting the honeycombs inside the beehive and heat them all simultaneously if the internal and/or external temperature of the beehive is below a predetermined temperature and heat them in sequence if the internal and/or external temperature of the beehive is above said predetermined temperature. In this way all of the brooding areas of the frames are treated.

### Description

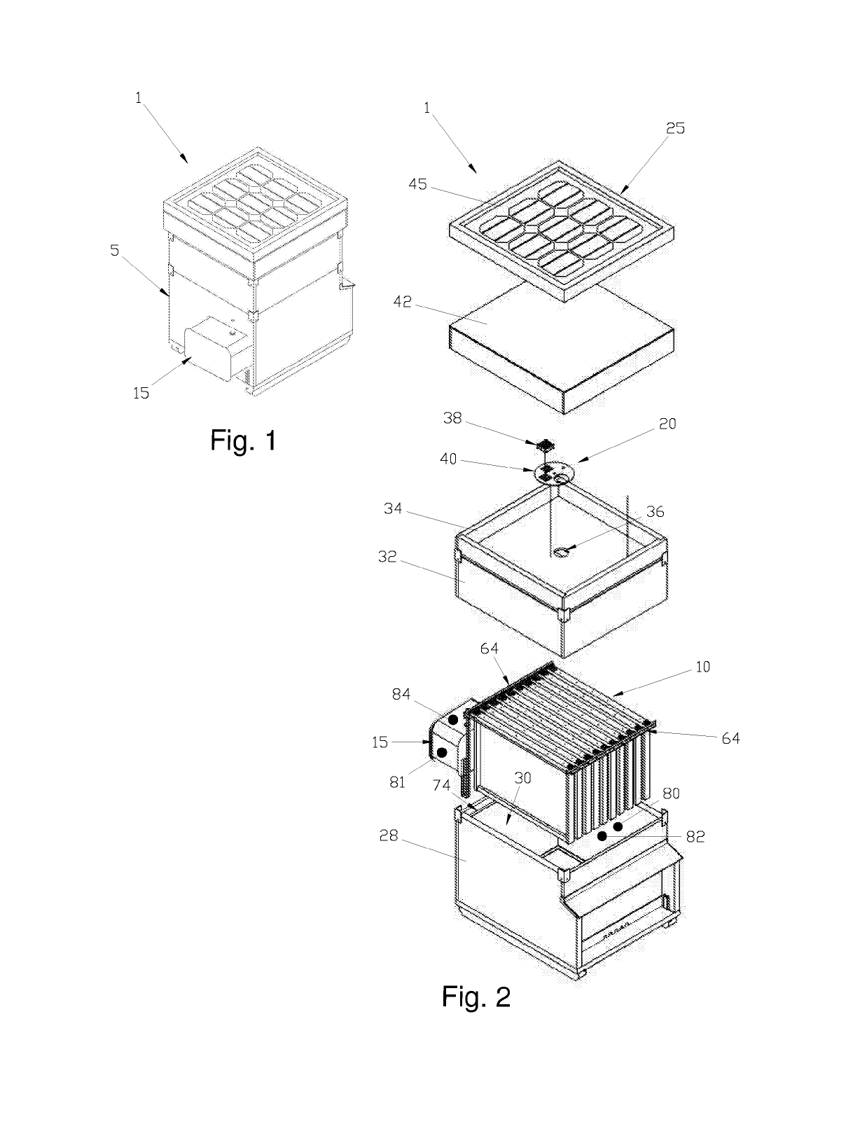

With reference to FIGS. 1 and 2 a beehive for treating a colony of bees against the Varroa mite is shown wholly indicated with reference numeral 1.

The beehive in the indicated example comprises a hive 5, a series of ten heatable frames 10 on which the bees can build the honeycombs contained inside it, a control device 15, a heat removal device 20 and a source of electric current 25.

The hive 5 comprises a first box-shaped element 28 that defines an inner space 30 used as housing for the frames 10. The hive can also optionally comprise one or more supers 32, i.e. a second box-shaped component that enlarges the space 30 to house a greater number of frames, and an upper closing cover 34 of the space 30.

The heat removal device 20 is intended to remove heat from the internal space 30 and comprises an opening 36, for the communication of said space with the outside, and a fan 38, arranged at said opening to remove the hot air present inside.

In order to prevent the bees from going into the fan, it is possible to use a screen 40 arranged between the opening 36 and the fan 38, equipped with a plurality of passages, for example holes or slits, suitable for the passage of air but not of insects. Preferably the screen 40 comprises a plurality of types of air passages and is mobile, for example rotatable, with respect to the opening 36 to select the type of passages arranged in front of the opening 36. The opening 36 is preferably made in the cover 34 of the space 30.

The source of electrical current 25 comprises a photovoltaic panel 45 arranged for example on a support 42 to form a cover of the hive 5. In this way, the device is energy-autonomous.

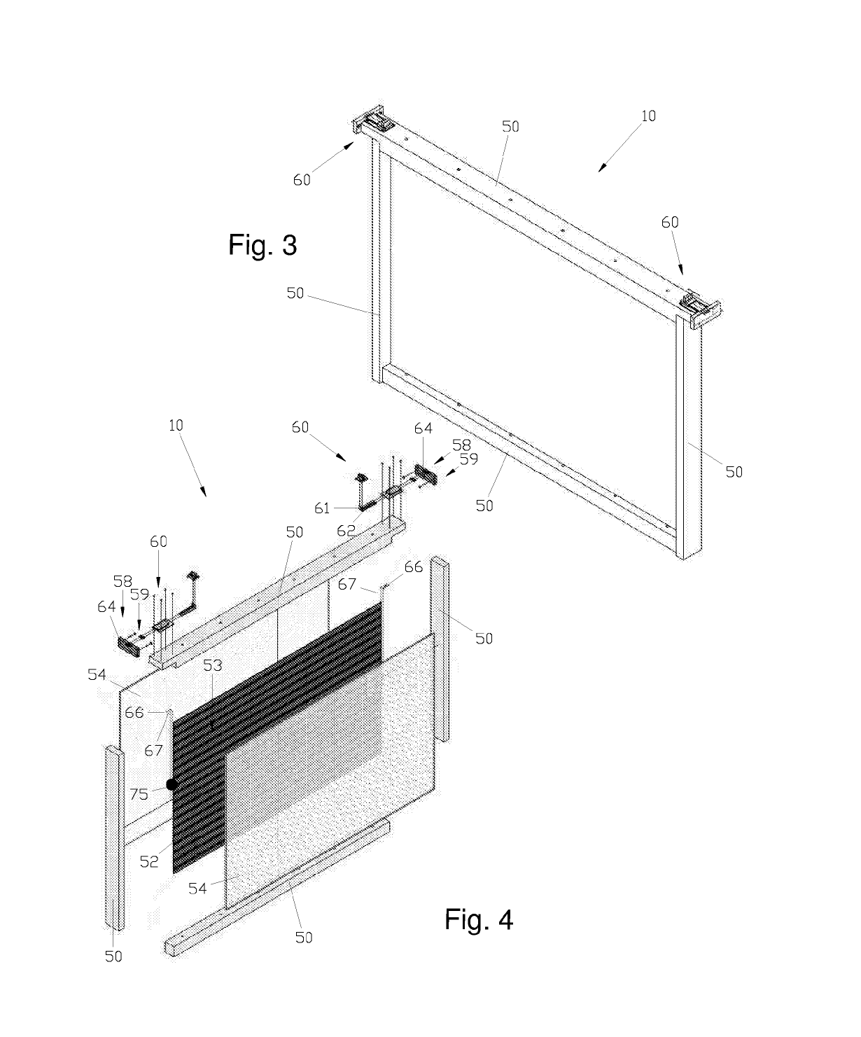

With reference to FIGS. 3 and 4, each frame 10 comprises an outer framework 50, a plate 52 with the faces 53 able to be heated homogeneously, and a pair of sheets 54 of beeswax directly resting on the faces able to be heated homogeneously of the plate 52.

The frame 10 does not directly have the honeycombs, but is intended to support those which the bees will build on it, to suit their own needs.

The framework 50 is for example made from wooden slats assembled together.

The plate 52 can be made in various ways, for example as a single block of electrically heatable material, so as to form a single flat electrical resistance. Indeed, this ensures the minimum bulk and therefore allows the greatest possible number of frames to be used in the hive. Solutions that are possible, but less preferred due to their bulk, consider the homogeneous heating of the faces of the plate 52 through a heat transmission phenomenon from the inside of the plate 52 to its faces by conduction, convection or radiation.

For example, it is possible to make the plate 52 as a tank of hot air or water.

In any case, it is preferable for the faces able to be heated homogeneously of the plate 52 to be defined by smooth or substantially smooth surfaces, in the sense that they have no recesses able to be exploited as honeycombs.

In the illustrated example, in which the heatable plate 52 is a single electrical resistance in the form of a board, it is electrically connected to the control device 15 (FIG. 2) through first electrical connections 58 at its ends.

Each frame 10 supports, on the framework 50, two enabling or exclusion device 60 capable of selectively interrupting said first electrical connections 58 at the two ends of the resistance.

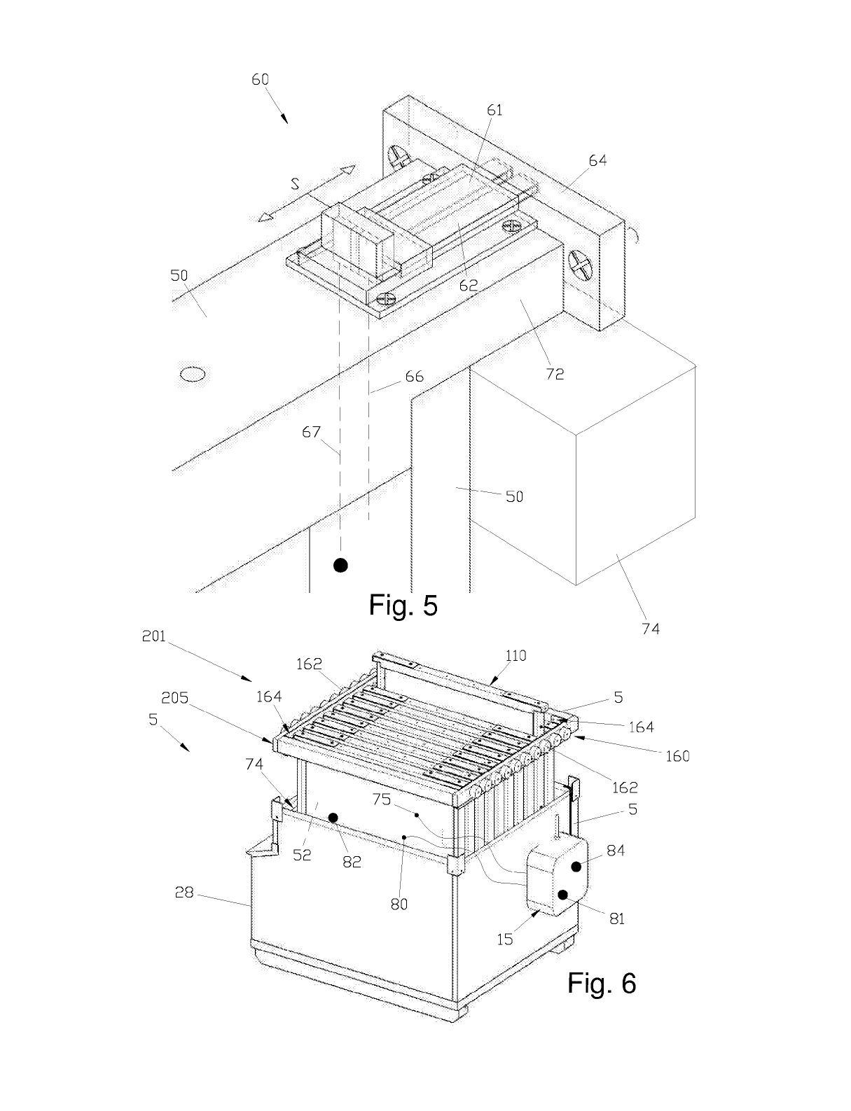

The enabling/exclusion device 60 is more clearly visible in the enlarged detail of FIG. 5.

Here it should be noted that it comprises a bayonet switch 62 capable of sliding by means of a manual action in the direction S of the figure with respect to the framework 50 to go into connection or move away from an electrically conductive element 64 fixed to the wall of the hive 28 and electrically connected to the control device 15.

When the switch 62 is inserted in the conductive element 64, the plate 52 can be supplied electrically through the cable 66, otherwise it is not able to be supplied.

It is thus clear that the first electrical connections 58 comprise at least one conductive element 64 and a cable 66 at each end of the plate 52.

It should be noted that the frame 10 comprises a pair of projecting portions 72 of framework 50 to rest on respective support steps 74 made in the hive. When the switch 62 is connected, the frame 10 rests on the steps 74 but cannot be extracted from the hive, whereas when the switch is disconnected, the frame is free to be extracted. This type of support and electrical connection also allows the frames to be extracted and reinserted into the hive with opposite orientation to that in which it started.

As can be seen more clearly in FIG. 1, the steps 74 extend for a sufficient length to allow all of the frames 10 to be supported, and the two conductive elements 64 (one for each side of the frames), also have a sufficient length to allow the electrical contact of each conductive element 64 with all of the frames 10.

It should not be observed that each frame 10 comprises a temperature sensor 75 connected to the control device 15 through second electrical connections 59 interrupted by the same enabling/exclusion devices 60 already described. In particular, these devices 60 comprise a second bayonet switch 61 able to be inserted and extracted from the conductive element 64 to respectively connect and insulate the cable 67 of the temperature sensor 75 from the control device 15 through a manual action.

Thanks to this provision the frames remain extractable from the hive, and moreover the apiarist can select which to activate to be managed by the control system. The activation simply requires the displacement of the bayonet switches to restore the contacts with the elements 64.

The control device 15 comprises a CPU (Central Processing Unit) programmed to manage the heating of the frames 10 according to at least one treatment programme against Varroa. The CPU manages the supply of current from the source 25 to the panels 10 that have been selectively arranged in active configuration by the apiarist through the enabling/exclusion devices.

The CPU also receives and processes the information relating to the temperature of the frames 10 through the sensor 75.

The beehive 1 also comprises at least one sensor 80 of the internal temperature of the hive, and/or a sensor 81 of the external temperature (FIG. 2). The information of these sensors is sent to the CPU to be processed.

In particular, the CPU can be programmed to keep the temperature of each frame between 38° C. and 45° C. for a predetermined time period, for example comprised between 5 minutes and 2 hours. The control of the desired temperature of the frame is carried out by the CPU with the help of the frame temperature sensor 75.

The CPU can also be programmed to select a treatment programme among a plurality of them based on the internal and/or external temperature of the hive detected with the sensors 80 and/or 81.

For example, if the sensor 81 detects that the external temperature is below a predetermined value, for example 28° C., it can command the heating of all of the frames simultaneously, whereas if it is above this value it can command the heating of the frames according to a predetermined sequence.

The CPU can also be programmed to keep the internal temperature below a predetermined value, for example 35° C., starting up the fan 38 during the treatment when the sensor 80 detects that this value has been exceeded.

With reference to FIGS. 6, 7 and 8 an alternative embodiment of a beehive 101 is shown, where identical or similar parts are indicated with the same reference numeral used earlier, or with the same number increased by 100.

The beehive 101 differs from the beehive 1 described earlier mainly for the enabling/exclusion device 160.

The latter comprises a plurality of screws or bayonets 162 able to be inserted from outside of the beehive inside it until the heatable frames 110 and a pair of electrically conductive tracks 164 common to all of the frames 110 are placed in electrical communication. In the illustrated example each screw or bayonet 162 is an at least partially conductive element having a shape and extension such as to pass through a wall of the hive 5 through suitable openings 163A, to pass through openings 163B through a fixed conductive track 164 preferably inside the hive, and to end by inserting into an opening 163C of an electrically conductive element 162A of a frame 110. The openings 163A, 163B and 163C are aligned with each other, for example when the frames are supported in operative position on the steps 74. Each screw or bayonet 162 is equipped, at the opposite end to that intended to insert in a frame 110, with a knob 162B to facilitate the insertion and disinsertion thereof. Each frame 110 can be connected to both of the tracks 164 through two respective screws or bayonets 162 so as to allow the circulation of current in the frame itself. The conductive elements 162A of the frame are indeed connected to the heating plate 52.

In order to arrange a frame 110 in the active state it will be sufficient to insert the relative bayonets 162 in the aligned openings, whereas to arrange it in a passive state, it is sufficient to disinsert them. It is clear that screws are in this case more advantageous, since they can be more easily supported by the hive also when they are in the passive state, in particular when the openings 163A are threaded holes, so that they are not lost.

Advantageously the beehive 101 prevents the enabling/exclusion device 160 from being covered with material such as propolis and/or wax by the bees, become unusable for the selection of the frames to be heated and/or for their extraction, or requiring a cleaning intervention to be used.

As can be seen the sensors 75, 80, 81, 82 described with respect to the beehive are still all present. As far as the temperature sensor of the frames 75 is concerned, although a screw or bayonet system like the one just described is not ruled out for its electrical connection to the control device 15, it is preferable to adopt a simplified connection through a cable, for example able to be inserted and disinserted from the frame and/or from the control device with a pin/jack system 165 or similar.

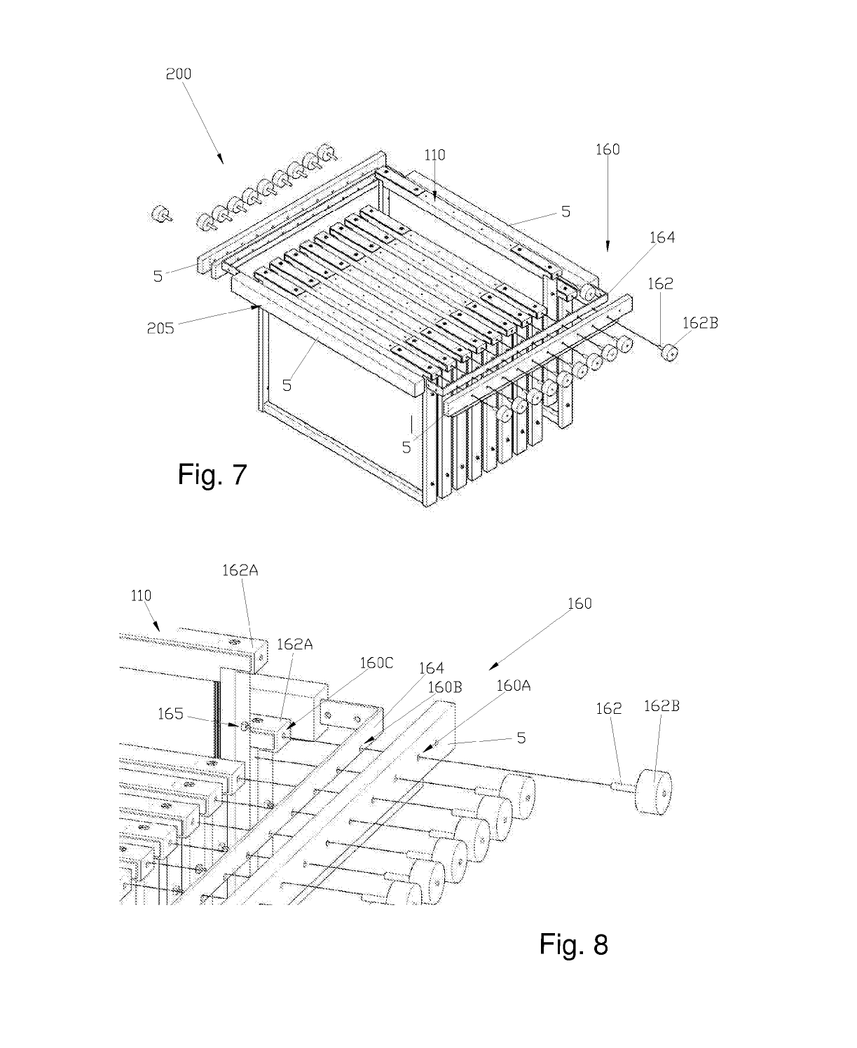

In the case in which it is wished to adapt pre-existing standard beehives, it is possible to provide an adaptation kit 200 (indicated in FIG. 7) comprising the frames 110, the tracks 164, the screws or bayonets 162, the whole thing supported by a frame 205 of a size such as to be able to stack onto the box-shaped element 28 of the hive 5, so as to form part of its outer wall at the same time keeping the frames inside the hive.

### Example 1 for Use in the Treatment of Varroa

In the case in which the colony is particularly attacked by Varroa, it is possible to carry out many treatments, for example 3, single or multiple, during the year (start of spring, end of summer, before winter) with the following process/programme of the CPU:
the apiarist manually arranges all of the heatable frames 10, 110 of the hive in active state by selecting them through the enabling/exclusion devices 60, 160;
the CPU commands the heating of each frame a 42° C. for one hour, for example with the help of the temperature sensor 75 of each frame 10, 110;
the CPU controls the external temperature of the hive through the sensor 81;
if the external temperature is greater than or equal to 28° C. the CPU commands the heating of the frames in sequence one after the other, or two at a time, for a total treatment time of 10 or 5 hours respectively;
if the external temperature is less than 28° C. the CPU commands the heating of all of the frames simultaneously, for a total treatment time of 1 hour;
the CPU starts up the fan 38 when during the treatment the sensor 80 detects that the internal temperature of the hive exceeds 36° C.

Experimental results demonstrate that the Varroa mites present in the brood die with a percentage close or equal to 100% without damaging the eggs, the larvae, the pupae and the adult bees. The colony is thus totally kept healthy.

### Example 2 for Use in the Treatment of Varroa

In the case in which the colony has a low degree of infestation and it is wished to carry out a preventive treatment to avoid the propagation thereof, the following procedure/programme of the CPU can be applied:
the apiarist evaluates the extent of the infestation and manually arranged only the frames involved in active state selecting them through the enabling/exclusion devices 60, 160;
the CPU heats each active frame to 42° C. and maintains such a temperature for at least 10 minutes, for example with the help of the temperature sensor 75 of each frame;
the CPU commands the simultaneous heating of all of the active frames;
the CPU commands the starting of the fan 38 when during the treatment the sensor 80 detects that the internal temperature of the hive exceeds 36° C.

It should be observed that in general the fan 38 could always be commanded to start irrespective of the temperature whenever a treatment is carried out.

Among the possible variants, even if less preferred, simpler treatment devices are foreseen where the temperature sensors are absent, where the frames, when switched on, are able to heat up to a predetermined nominal temperature, for example 42° C., and where the control device is a simple switch that, when switched on, starts the heating of the frames, which automatically reaches only up to the nominal temperature, and starts the fan 38. The treatment time in this case is selected arbitrarily by the apiarist.

It should also be observed that in the examples given reference has always been made to ten heatable frames, since standard hives normally contain 10 frames (not heatable). The man skilled in the art will understand that this must not be considered an insuperable limit, with it being possible to adopt a greater or smaller number of frames and/or different hive and frame dimensions from those of standard hives and frames.

Preferably, all of the frames of a hive are heatable, even if it is possible for some not to be.

The man skilled in the art will note that by simply adding a humidity sensor 82 inside the hive in communication with the CPU, and with simple programming of the latter, the beehive 1 can operate as an climate control system of the hive.

### Example 1 for Climate Control of the Hive

In the period from mid-spring to end of summer it is possible to control the humidity and the temperature present inside the hive with the following procedure/programme of the CPU.
the CPU detects the humidity and the temperature inside the hive through the sensor 82;
if the relative humidity exceeds a predetermined threshold, for example 50-60%, the CPU commands the heating of one or more frames up to a predetermined maximum temperature, for example 35° C. (so as not to stress the bee eggs);
the CPU commands the starting of the fan 38 when the temperature inside the hive exceeds 35° C.

In this way, the climate control device 1 helps and/or replaces the worker bees in the climate control of the beehive, with a consequent lower consumption of energy and therefore of honey, royal jelly and pollen, which remain for the apiarist.

### Example 2 for Climate Control of the Hive

In the period from the end of summer to the start of spring it is possible to reduce the energy consumption of the colony and/or reduce humidity with the following procedures/programmes of the CPU.

### Reduction of Energy Consumption of the Bees

the apiarist selects the frames on which he intends for the colony to spend the winter arranging them in active state;
the CPU commands the heating of the active frames up to a temperature less than or equal to a predetermined temperature, for example 35° C., and maintains such a temperature for the entire period.

### Reduction in Humidity

For this procedure it is necessary to integrate the beehive 1, 101 also with an external relative humidity sensor 84 communicating with the CPU.
the CPU detects the relative humidity inside the hive through the sensor 82;
if the detected relative humidity value is greater than a predetermined value, for example 50%, the CPU commands the heating of the active frames up to a first temperature of less than 45°, for example 35° C.;
if after a predetermined time the CPU does not detect a lowering of the internal relative humidity, and detects an external relative humidity that is higher than the internal relative humidity through the external sensor 84, it commands the starting of the fan 38 to replace the air inside the hive;
in the case in which the external humidity is greater than the internal humidity, the CPU, instead of commanding the replacement of internal air, will command the heating of the active frames to a second temperature of less than 45° C. and greater than the first temperature, for example 38° C.

The man skilled in the art will realise that although here an climate control system has been described combined with the beehive for treating against Varroa, for clear advantages in construction and use, the two can also be distinct and/or independent from the presence of the other, for example with it not being strictly necessary for the climate control system that the heating elements be the frames of the hive and/or with it not being strictly necessary for there to be internal and external temperature sensors.

It should also be observed that the treatment beehive and/or the climate control system can be combined with a telecommunications system to converse with a remote control, like for example a mobile telephone programmed with an application capable of managing the CPU 15.

The remote control for example receive the data relative to the state of the hive and corresponding to the readings of the sensors, shows it to the apiarist, and allows him to send commands to the CPU on the action to be taken and/or set the desired operating methods. In the case of the presence of an application for remote control (for example mobile telephone) it will be able to allow the apiarist to fill in the record of his activities linked to the hive keeping an archive, always visible by the remote control).

While the invention has been described with reference to the embodiments above, a person of ordinary skill in the art would understand that various changes or modifications may be made thereto without departing from the scope of the claims.

1. Beehive suitable for the treatment of a colony of bees inside it against the infestation of mites, comprising:
a plurality of frames (10) for supporting the honeycombs (10), wherein said frames (10) do not have pre-built honeycombs to house the eggs of the bees, so that they can be built by the bees to suit their needs, said frames (10) being able to be heated inside the beehive (1),
the frames (10) being able to be heated up to a maximum temperature of less than 45° C.

2. Beehive of claim 1, wherein all of the frames (10) of the beehive (1) are without pre-built honeycombs and are heatable.

3. Beehive of claim 1, wherein the frames (10) can be heated for a predetermined time period.

4. Beehive of claim 1, wherein the heating of all of said frames (10) is controlled by the same control device (15).

5. Beehive of claim 1, wherein the frames (10) are extractable from the beehive (1), and when inserted in the beehive (1) are adjacent to electrical contacts (64, 164) that are fixed with respect to the beehive capable of exchanging current with corresponding electrical contacts (61, 62, 162A) of the frames so as to supply them with the current so as to heat up.

6. Beehive of claim 1, wherein the electrical contacts (61, 62, 64, 162A, 164) are in a position such that the insertion of the frames (10) in the beehive (1) in a position supported by the support elements (74) places said electrical contacts in operative contact with each other, or in a position such that they can be placed in operative contact through a bayonet or through screw device (61, 62, 162).

7. Beehive of claim 1, further comprising at least one enabling/exclusion device (60, 160) able to be selectively actuated by the apiarist to allow or prevent the heating of at least one frame (10).

8. Beehive of claim 1, wherein each heatable frame (10, 110) is associated with an enabling/exclusion device (60, 160) to allow or prevent the heating thereof independently from the others.

9. Beehive of claim 1, further comprising an external temperature sensor (81) and/or an internal temperature sensor (80) of the beehive, and a control device (15) configured to heat all of the heatable frames (10, 110) simultaneously if the external and/or internal temperature is below a predetermined temperature and to heat the heatable frames (10, 110) according to at least one predetermined sequence if the external and/or internal temperature is above said predetermined temperature.

10. Beehive of claim 1, wherein each heatable support frame of the honeycombs (10, 110) comprises at least one peripheral framework (50), at least one plate (52) with faces (53) able to be heated homogeneously and a bee's wax cover (54) placed directly on said faces (53) and on which the bees will build the honeycombs to suit their needs.

11. Beehive of claim 1, further comprising at least one device (20) for taking heat away from the inside of the beehive (30).

12. Beehive of claim 1, further comprising at least one temperature sensor (80) to measure the temperature inside the beehive, the beehive (1, 101) being programmed to actuate the heat removal device (20) based on the temperature inside the beehive (5).

13. Heatable support frame of the honeycombs for a beehive, wherein the support frame does not have pre-built honeycombs and comprises at least one peripheral framework (50), at least one plate (52) with faces able to be heated homogeneously (53) and a bee's wax cover (54) placed directly on said faces (53) and on which the bees will build the honeycombs to suit their needs.

14. Method for treating a colony of bees against the infestation of mites, comprising:
heating all of the brooding areas (10), male and female, of a beehive to a first temperature sufficient to kill possible mites;
controlling the temperature of said brooding areas (10, 110) and/or inside the beehive (5) so that it remains below a predetermined temperature suitable for not killing the eggs, larvae, pupae and adult bees.

15. Method of claim 14, wherein said heating of the brooding areas (10, 110) is taken to a maximum temperature of less than 45° C., and/or said temperature inside the beehive is kept less than or equal to 35° C.

16. Method of claim 14, further comprising heating all of the brooding areas simultaneously if the internal and/or external temperature of the beehive is below a predetermined temperature and heating them in sequence if the internal and/or external temperature of the beehive is above said predetermined temperature.
